(19) United States
(12) Patent Application Publication
(10) Pub. No.: US 2017/0034195 A1
(43) Pub. Date: Feb. 2, 2017

(54) APPARATUS AND METHOD FOR DETECTING ABNORMAL CONNECTION BEHAVIOR BASED ON ANALYSIS OF NETWORK DATA

(71) Applicant: ELECTRONICS AND TELECOMMUNICATIONS RESEARCH INSTITUTE, Daejeon (KR)

(72) Inventors: Jong-Hoon LEE, Daejeon (KR); Ik-Kyun KIM, Daejeon (KR)

(21) Appl. No.: 15/004,412

(22) Filed: Jan. 22, 2016

(30) Foreign Application Priority Data
Jul. 27, 2015 (KR) 10-2015-0105866

(51) Int. Cl. H04L 29/06

(52) U.S. Cl. CPC H04L 63/1425

(57) ABSTRACT

An apparatus and method for detecting abnormal connection behavior are disclosed. The apparatus for detecting abnormal connection behavior includes a data extraction unit, a data storage unit, and a detection unit. The data extraction unit collects network data transmitted and received over a network including a plurality of hosts, and extracts data required for the detection of abnormal connection behavior from the network data. The data storage unit stores the extracted data required for the detection of abnormal connection behavior. The detection unit detects abnormal connection behavior based on characteristic factors corresponding to the stored data required for the detection of abnormal connection behavior and characteristic factors corresponding to malicious behavior.

### CROSS-REFERENCE TO RELATED APPLICATION

This application claims the benefit of Korean Patent Application No. 10-2015-0105866, filed Jul. 27, 2015, which is hereby incorporated by reference herein in its entirety.

### BACKGROUND

1. Technical Field

Embodiments of the present invention relate generally to an apparatus and method for detecting abnormal behavior over a network including a plurality of hosts, and more particularly to technology that collects and analyzes network data and detects abnormal behavior based on the connection information of a network and service information.

2. Description of the Related Art

In general, network intrusion detection systems cannot detect a new type of attack that is previously unknown or malicious behavior that disguises itself as normal behavior because they define rules based on known attacks or malicious behavior and recognize external intrusion based on these rules. For example, conventional security equipment cannot block behavior in which malware that disguises itself as a normal program is downloaded to a user in such as manner that an attacker intrudes into a vaccine program update server, changes the redirect address of the vaccine update server, and vaccine update is performed from a malicious server designated by the attacker himself or herself.

Furthermore, generally, Intrusion Detection Systems (IDSs) that detect intrusion into a network can detect attacks, such as Distributed Denial of Service (DDoS), port scan and an attempt to crack a computer, but have a limitation in terms of the recognition of and protection against a recent type of attack known as an Advanced Persistent Threat (APT), which is deliberately performed over a long latency period. Accordingly, there is a need to recognize and detect attacks, which are secretively performed, by analyzing the relationships between various pieces of data collected over a network, rather than simply blocking a single attack factor. Furthermore, since the amount of network information inside a network, which is collected by network collection equipment, is massive, conventional methods cannot perform the total inspection of all connections, and there is a limitation on the storage of the information. Accordingly, there is a need for a method of selecting and analyzing specific connections.

Korean Patent Application No. 2012-0007986 discloses a technology for detecting a relational attack pattern, thereby reducing the erroneous detection rate of an intrusion blocking system.

However, Korean Patent Application No. 2012-0007986 does not teach a technology for detecting abnormal behavior based on connection information and service information with respect to collected network data.

Accordingly, in light of a recent increase in Advanced Persistent Threats (APTs), which are deliberately performed over a long latency period, there is a need for technology for detecting abnormal behavior, in advance, using characteristic factors with respect to collected network data based on connection information and service information.

### SUMMARY

At least one embodiment of the present invention is intended to analyze network data using characteristic factors, thereby detecting an APT which cannot be detected using a conventional method and which is secretively performed over a continuous period of time.

At least one embodiment of the present invention is intended to selectively analyze network data without performing total inspection, thereby more rapidly detecting abnormal behavior.

According to an aspect of the present invention, there is provided an apparatus for detecting abnormal connection behavior, including: a data extraction unit configured to collect network data transmitted and received over a network including a plurality of hosts, and to extract data required for the detection of abnormal connection behavior from the network data; a data storage unit configured to store the extracted data required for the detection of abnormal connection behavior; and a detection unit configured to detect abnormal connection behavior based on characteristic factors corresponding to the stored data required for the detection of abnormal connection behavior and characteristic factors corresponding to malicious behavior.

The characteristic factors may include any one or more of a used service count, an inbound flow, an outbound flow, connection duration, an In packet count, an Out packet count, and a connection count.

The data extraction unit may include: a raw data extraction unit configured to extract network data, for which a specific or longer period of time has elapsed, from the collected network data; a connection information data extraction unit configured to extract data corresponding to connection information from the collected network data; a service information data extraction unit configured to extract data corresponding to service information from the collected network data; and a malicious behavior data extraction unit configured to extract network data that occurs due to malicious behavior.

The detection unit may include: an external IP address extraction unit configured to extract an external IP address based on information about an IP address included in the data corresponding to the connection information; a suspicious abnormal data extraction unit configured to check whether the external IP address has been previously connected by comparing an external IP address stored in the data storage unit with the former external IP address, and to extract network data, related to an external IP address that has not been previously connected, as suspicious abnormal behavior data; and an abnormal connection detection unit configured to detect abnormal behavior based on characteristic factors corresponding to the suspicious abnormal behavior data and characteristic factors corresponding to the malicious behavior.

The suspicious abnormal behavior extraction unit may compare the inbound flow, the outbound flow, the In packet count and the Out packet count included inside the connection data with connection data stored in the data storage unit, and may determine that behavior in question is normal behavior if a result value is equal to or lower than a threshold value.

The detection unit may include: a service name extraction unit configured to extract a service name from the service information; a destination IP extraction unit configured to extract network data having a service name identical to the service name from network data stored in the data storage unit, and to extract a destination IP address corresponding to the network data; a suspicious abnormal behavior extraction unit configured to compare a destination IP address corresponding to the network data stored in the data storage unit with the destination IP address, and to extract the network data as suspicious abnormal connection data if the destination IP addresses do not match each other; and an abnormal connection detection unit configured to detect abnormal connection based on characteristic factors corresponding to the suspicious abnormal connection data and characteristic factors corresponding to the malicious behavior.

The suspicious abnormal behavior extraction unit, in the case of network data from which the service name cannot be extracted, may map the destination IP address against an IP address stored in the data storage unit, may determine whether the destination IP address is an IP address stored in the data storage unit, and may extract the network data as suspicious abnormal connection data if the destination IP address is not an IP address stored in the data storage unit.

The abnormal connection detection unit may detect abnormal connection based on similarity between the values of the characteristic factors.

The apparatus may further include a graph output unit configured to output the network data represented by the characteristic factors and data corresponding to the malicious behavior in a graph form.

According to another aspect of the present invention, there is provided a method of detecting abnormal connection behavior, including: collecting network data transmitted and received over a network including a plurality of hosts, and extracting data required for the detection of abnormal connection behavior from the network data; storing the extracted data required for the detection of abnormal connection behavior; and detecting abnormal connection behavior based on characteristic factors corresponding to the stored data required for the detection of abnormal connection behavior and characteristic factors corresponding to malicious behavior.

The characteristic factors may include any one or more of a used service count, an inbound flow, an outbound flow, connection duration, an In packet count, an Out packet count, and a connection count.

Detecting the data may include: extracting network data, for which a specific or longer period of time has elapsed, from the collected network data; extracting data corresponding to connection information from the collected network data; extracting data corresponding to service information from the collected network data; and extracting network data that occurs due to malicious behavior.

Detecting the abnormal connection behavior may include: extracting an external IP address based on information about an IP address included in the data corresponding to the connection information; checking whether the external IP address has been previously connected by comparing an external IP address stored in the data storage unit with the former external IP address, determining network data, related to an external IP address that has not been previously connected, to be suspicious abnormal behavior data, and extracting the suspicious abnormal behavior data; and detecting abnormal behavior based on characteristic factors corresponding to the suspicious abnormal behavior data and characteristic factors corresponding to the malicious behavior.

Determining network data to be suspicious abnormal behavior data and extracting the suspicious abnormal behavior data may include comparing the inbound flow, the outbound flow, the In packet count and the Out packet count included inside the connection data with connection data stored in the data storage unit, and determining that behavior in question is normal behavior if a result value is equal to or lower than a threshold value.

Detecting the abnormal connection behavior may include: extracting a service name from the service information; extracting network data having a service name identical to the service name from network data stored in a data storage unit, and extracting a destination IP address corresponding to the network data; comparing a destination IP address corresponding to the network data stored in the data storage unit with the destination IP address, and extracting the network data as suspicious abnormal connection data if the destination IP addresses do not match each other; and detecting abnormal connection based on characteristic factors corresponding to the suspicious abnormal connection data and characteristic factors corresponding to the malicious behavior.

Determining network data to be suspicious abnormal behavior data and extracting the suspicious abnormal behavior data may include, in the case of network data from which the service name cannot be extracted, mapping the destination IP address against an IP address stored in the data storage unit, determining whether the destination IP address is an IP address stored in the data storage unit, and extracting the network data as suspicious abnormal connection data if the destination IP address is not an IP address stored in the data storage unit.

Detecting the abnormal connection behavior may include detecting abnormal connection based on similarity between the values of the characteristic factors.

The method may further include outputting the network data represented by the characteristic factors and data corresponding to the malicious behavior in a graph form.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing an apparatus for detecting abnormal connection behavior based on the analysis of network data according to an embodiment of the present invention;

FIG. 2 is a block diagram showing embodiments of the data extraction unit and the data storage unit shown in FIG. 1;

FIGS. 3 and 4 are block diagrams showing embodiments of the detection unit shown in FIG. 1;

FIG. 5 is a graph showing abnormal data in an apparatus for detecting abnormal connection behavior based on the analysis of network data according to an embodiment of the present invention;

FIG. 6 is an operation flowchart showing a method of detecting abnormal behavior based on the analysis of network data according to an embodiment of the present invention; and

FIGS. 7 and 8 are operation flowcharts showing the step of detecting abnormal behavior, which is shown in FIG. 6, greater detail.

FIG. 9 illustrates a computer that implements an apparatus for detecting abnormal connection behavior based on the analysis of network data according to an example.

### DETAILED DESCRIPTION

Embodiments of the present invention will be described in detail below with reference to the accompanying drawings. Redundant descriptions and descriptions of well-known functions and configurations that have been deemed to make the gist of the present invention unnecessarily obscure will be omitted below. The embodiments of the present invention are intended to fully describe the present invention to persons having ordinary knowledge in the art to which the present invention pertains. Accordingly, the shapes, sizes, etc. of components in the drawings may be exaggerated to make the description obvious.

Embodiments of the present invention are described in detail with reference to the accompanying diagrams.

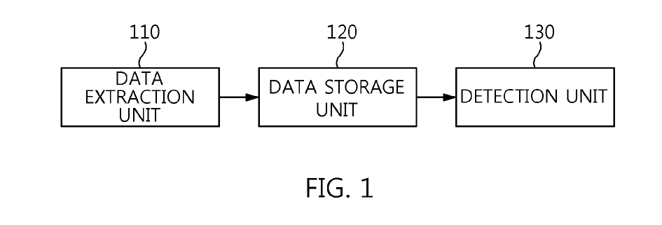

FIG. 1 is a block diagram showing an apparatus for detecting abnormal connection behavior based on the analysis of network data according to an embodiment of the present invention.

Referring to FIG. 1, the apparatus for detecting abnormal connection behavior based on the analysis of network data according to the present embodiment includes a data extraction unit 110, a data storage unit 120, and a detection unit 130.

The data extraction unit 110 collects network data transmitted and received over a network including a plurality of hosts, and extracts data required for the detection of abnormal connection from the network data.

In this case, the data required for the detection of abnormal connection may refer to connection data regarding connection between hosts over the network.

In this case, the connection data may include connection start time, connection end time, duration, a source IP address, a destination IP address, a source port, a destination port, a protocol, inbound flow bytes, outbound flow bytes, In packets, Out packets, a service name, a service provider, etc.

In this case, the data required for the detection of abnormal connection may be data including connection information.

In this case, the connection information may include a source IP address, a destination IP address, an occurrence count, an average packet count, an average flow count, and recent occurrence time.

In this case, the data extraction unit 110 may extract the data required for the detection of abnormal connection, including the connection information, in real time, may classify the data required for the detection of abnormal connection, and may store the data required for the detection of abnormal connection in the data storage unit 120.

In this case, the data required for the detection of abnormal connection may be data including service information.

In this case, the service information may include a service name, a source IP address, and a destination IP address.

In this case, the data extraction unit 110 may extract the data required for the detection of abnormal connection, including the service information, in real time, may classify the data required for the detection of abnormal connection, and may store the data required for the detection of abnormal connection in the data storage unit 120.

In this case, in the detection of suspicious abnormal connection data, occurring data may be detected as suspicious abnormal connection data due to unknown connection detection. For example, when time N is defined as a 1 minute, connection data whose number of occurrences per minute is three or less is selected, and the class B of the Internet Protocol (IP) thereof is analyzed. If, as a result of the analysis, the address of the class B has been stored in a raw data storage unit 10 or less times, the occurring data may be detected as suspicious abnormal connection data.

In this case, in the detection of suspicious abnormal connection data, an unknown service that has not been classified may be compared with existing classified sub-data, a service that has not been analyzed may be detected based on the results of the comparison, whether mapping to IP class B of HTTP, UDP or TCP, which are unclassified services, has been accomplished may be analyzed, and a none-matching connection may be detected as suspicious abnormal connection data.

In this case, in the detection of suspicious abnormal connection data, whether an IP address connected to a connection from which a service name can be collected matches an IP address stored in the data storage unit 120 may be analyzed, and a connection for which an IP address does not match an IP address stored in the data storage unit 120 may be detected as suspicious abnormal connection data.

In summary, the extraction unit 110 extracts real-time network data from data classified by a data classifier, and extracts three types of analysis target connection data through classification.

In this case, the extraction unit 110 may extract i) data corresponding to connection for which an occurrence count of the connection of SRC IP or Dest IP is 10 or less within a connection list table during time N, ii) data corresponding to connection for which an L7 service name is extracted as a specific service by network data collection equipment, and iii) data corresponding to connection for which a service name is not extracted as specific service by network data collection equipment and is labeled with HTTP, UDP, TCP or the like.

In this case, the data extraction unit 110 tests a plurality of malicious behavior codes on an actual host in order to collect malicious behavior data, in which case occurring network data and connection data may be stored in the data storage unit 120.

In this case, the data extraction unit 110 may extract network data, for which a specific or longer period of time has elapsed, from the collected network data, and may store the extracted data in the data storage unit 120. The reason for this is to use the network data, for which a specific or longer period of time has elapsed, in order to detect abnormal behavior because the network data, for which a specific or longer period of time has elapsed, has a strong possibility of not being network data attributable to abnormal behavior.

The data storage unit 120 stores the extracted data required for the detection of abnormal connection.

In this case, the data required for the detection of abnormal connection may be data including connection information.

In this case, the connection information may include a source IP address, a destination IP address, an occurrence count, an average packet count, an average flow count, and recent occurrence time.

In this case, the data required for the detection of abnormal connection may be data including service information.

In this case, the service information may include a service name, a source IP address, and a destination IP address.

In this case, the data storage unit 120 may store data, collected within time N from current time based on the collection time of the collected data, in a real-time data storage unit (not shown). Data collected before time N may be stored in the raw data storage unit.

The detection unit 130 detects abnormal connection behavior based on characteristic factors corresponding to the stored data required for the detection of abnormal connection and characteristic factors corresponding to malicious behavior.

In this case, first, the detection unit 130 may extract suspicious abnormal connection data based on the data required for the detection of abnormal connection.

In this case, the suspicious abnormal connection data may refer to network data that occurs due to connection that is suspected to correspond to an abnormal state.

In this case, the suspicious abnormal connection data may include network data that occurs at an IP address, which has not been connected previously, outside the network.

In this case, whether the IP address has been connected previously may be determined using information inside connection information data stored in the data storage unit 120.

In this case, the detection unit 130 may extract a service name and a destination IP address from the data required for the detection of abnormal connection, may extract the destination IP address of network data having the same service name from service information stored in the data storage unit 120, may compare the destination IP addresses, and may determine that a connection state corresponding to the data required for the detection of abnormal connection is a suspicious abnormal connection state if the destination IP addresses do not match each other.

In this case, if a service name cannot be extracted from the data required for the detection of abnormal connection, the detection unit 130 may extract a destination IP address, may determine whether network data corresponding to the similar connections of network data having the same IP address is present in service information stored in the data storage unit 120, and may determine that a connection state corresponding to the data required for the detection of abnormal connection is a suspicious abnormal connection state if similar connections are not present.

In this case, the detection unit 130 may extract characteristic factors corresponding to suspicious abnormal connection data, may extract characteristic factors corresponding to network data attributable to malicious behavior stored in the data storage unit 120, and may compare the characteristic factors, thereby detecting abnormal connection.

In this case, if the characteristic factors have similar values, the detection unit 130 may determine that connection in question is abnormal connection and thus detect the abnormal connection.

In this case, the characteristic factors may include a used service count, an inbound flow, an outbound flow, connection duration, an In packet count, an Out packet count, a connection count, etc.

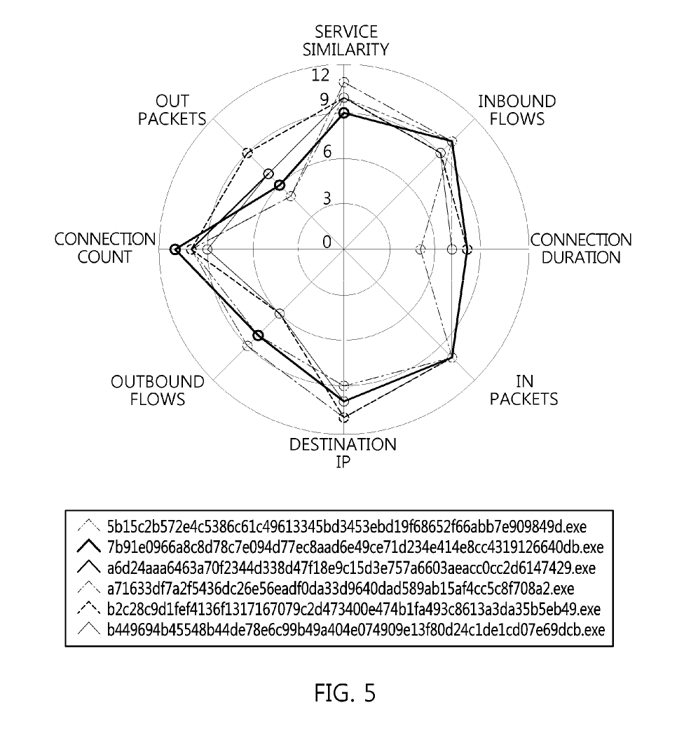

In this case, a graph plotting the values of characteristic factors may be output, and the state and similarity of malicious behavior most similar to network data may be also output. An example of this is shown in FIG. 5.

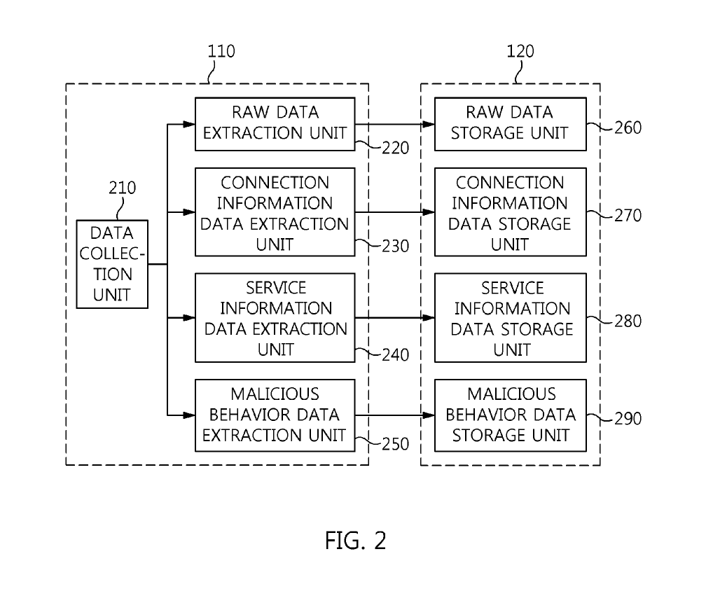

FIG. 2 is a block diagram showing embodiments of the data extraction unit 110 and the data storage unit 120 shown in FIG. 1.

Referring to FIG. 2, the data extraction unit 110 includes a raw data extraction unit 220, a connection information data extraction unit 230, a service information data extraction unit 240, and a malicious behavior data extraction unit 250, and the data storage unit 120 includes a raw data storage unit 260, a connection information data storage unit 270, a service information data storage unit 280, and a malicious behavior data storage unit 290.

The raw data extraction unit 220 extracts network data, for which a specific or longer period of time has elapsed, from data collected by the data collection unit 210 in real time.

The reason for this is to use the network data, for which a specific or longer period of time has elapsed, in order to detect abnormal behavior because the network data, for which a specific or longer period of time has elapsed, has a strong possibility of not being network data attributable to abnormal behavior.

The connection information data extraction unit 230 extracts data related to connection information inside the data collected by the data collection unit 210 in real time.

In this case, the connection information may include a source IP address, a destination IP address, an occurrence count, an average packet count, an average flow count, and recent occurrence time.

The service information data extraction unit 240 extracts data corresponding to service information from collected network data.

In this case, the data required for the detection of abnormal connection may be data including service information.

In this case, the service information may include a service name, a source IP address, and a destination IP address.

The malicious behavior data extraction unit 250 extracts network data that occurs due to malicious behavior.

The raw data storage unit 260 stores the network data extracted by the raw data extraction unit 220.

The connection information data storage unit 270 stores data related to connection information extracted by the connection information data extraction unit 230.

The service information data storage unit 280 stores data related to the service information extracted by the service information data extraction unit 240.

The malicious behavior data storage unit 290 stores the network data attributable to malicious behavior extracted by the malicious behavior data extraction unit 250.

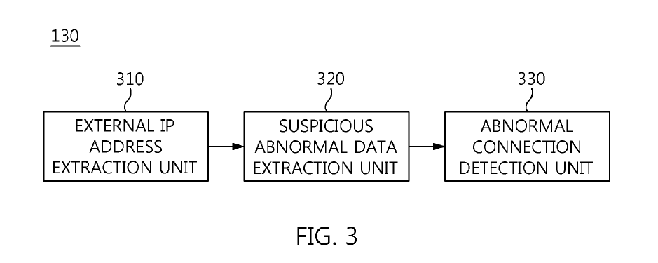

FIG. 3 is a block diagram showing an embodiment of the detection unit 130 shown in FIG. 1.

Referring to FIG. 3, the detection unit 130 includes an external IP address extraction unit 310, a suspicious abnormal data extraction unit 320, and an abnormal connection detection unit 330.

The external IP address extraction unit 310 extracts an external IP address based on information about an IP address included in network data corresponding to connection information.

In this case, the external IP address may refer to the IP address of a terminal that connects from the outside of a network to the inside of the network.

The suspicious abnormal data extraction unit 320 extracts suspicious abnormal data based on a previously connected external IP address stored in the data storage unit 120 and an external IP address extracted by the external IP address extraction unit 310.

In this case, the suspicious abnormal connection data may refer to network data that occurs due to connection that is suspected to correspond to an abnormal state.

In this case, the suspicious abnormal connection data may include network data that occurs at an IP address, which has not been connected previously, outside the network.

In this case, the previously connected external IP address may be extracted using connection information data stored in the connection information data storage unit 270.

In this case, it is determined whether the preciously connected external IP address stored in data storage unit 120 and the external IP address extracted by the external IP address extraction unit 310 are the same. If the external IP addresses are not the same, data in question is data from an IP address that has not been connected previously, and is thus extracted as suspicious abnormal connection data.

The abnormal connection detection unit 330 detects abnormal connection based on characteristic factors corresponding to suspicious abnormal connection data and characteristic factors corresponding to malicious behavior.

In this case, if it is determined through comparison between the characteristic factors that there is a plurality of characteristic factors having similar values, the abnormal connection detection unit 330 may determine that connection in question is abnormal connection and thus detect the abnormal connection.

In this case, the characteristic factors may include a used service count, an inbound flow, an outbound flow, connection duration, an In packet count, an Out packet count, a connection count, etc.

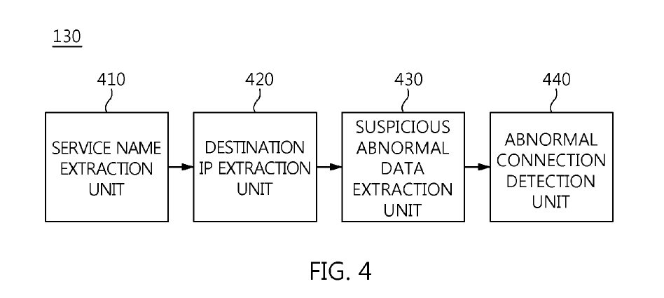

FIG. 4 is a block diagram showing another embodiment of the detection unit 130 shown in FIG. 1.

Referring to FIG. 4, the detection unit 130 includes a service name extraction unit 410, a destination IP extraction unit 420, a suspicious abnormal data extraction unit 430, and an abnormal connection detection unit 440.

The service name extraction unit 410 extracts a service name included in data corresponding to service information.

In this case, the service name refers to the name of a service that is the cause of the transmission and reception of network data.

The destination IP extraction unit 420 extracts a destination IP address, corresponding to network data having a service name identical to a service name extracted by the service name extraction unit 410, from network data stored in the data storage unit 120.

The suspicious abnormal data extraction unit 430 compares an IP address corresponding to network data with the IP address extracted by the destination IP extraction unit 420, determines that data in question is suspicious abnormal connection data if the IP addresses do not match each other, and extracts the suspicious abnormal connection data.

In this case, the suspicious abnormal connection data may refer to network data that occurs due to connection that is suspected to correspond to an abnormal state.

In this case, in the case of network data from which the service name extraction unit 410 cannot extract a service name, it is determined whether a destination IP address corresponding to the network data is an IP address stored in the data storage unit. If the destination IP address corresponding to the network data is an IP address not stored in the data storage unit, data in question may be determined to be suspicious abnormal connection data, and the suspicious abnormal connection data may be extracted.

In the case of data from which a service name cannot be extracted, the data is labeled with Hyper Text Transfer Protocol (HTTP), User Datagram Protocol (UDP), Transmission Control Protocol (TCP) or the like and then collected, and thus suspicious abnormal behavior may be extracted using a destination IP address. A destination IP address may be extracted, it may be determined whether network data corresponding to similar connections that belongs to network data having the same IP address is present in service information stored in the data storage unit 120, and a connection state corresponding to data required for the detection of abnormal connection may be determined to be a suspicious abnormal connection state if there are no similar connections.

The abnormal connection detection unit 440 detects abnormal connection based on characteristic factors corresponding to suspicious abnormal connection data and characteristic factors corresponding to malicious behavior.

In this case, if it is determined through comparison between the characteristic factors that there is a plurality of characteristic factors having similar values, connection in question is determined to be abnormal connection and thus the abnormal connection is detected.

In this case, the characteristic factors may include a used service count, an inbound flow, an outbound flow, connection duration, an In packet count, an Out packet count, a connection count, etc.

FIG. 5 is a graph showing abnormal data in an apparatus for detecting abnormal connection behavior based on the analysis of network data according to an embodiment of the present invention.

Referring to FIG. 5, it can be seen that inbound flows, connection duration, In packets, destination IP addresses, outbound flows, connection counts, Out packets, and service similarity are plotted in a graph.

In this case, a graph may be drawn using characteristic factors corresponding to data required for the detection of abnormal connection selected from network data.

In this case, network data corresponding to malicious behavior may be plotted in a graph using characteristic factors.

In this case, both network data and network data corresponding to malicious behavior may be plotted in a graph using characteristic factors.

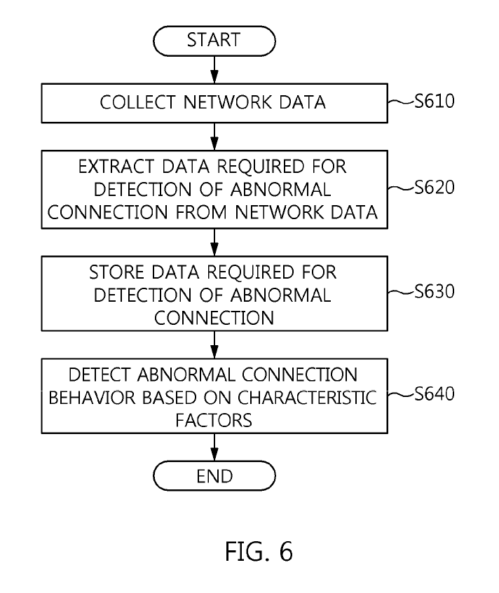

In this case, the graphs are not limited to a specific shape. As shown in FIG. 6, plotting may be performed using a radial graph.

FIG. 6 is an operation flowchart showing a method of detecting abnormal behavior based on the analysis of network data according to an embodiment of the present invention.

Referring to FIG. 6, first, network data is collected at step S610.

Furthermore, data required for the detection of abnormal connection is extracted from the network data at step S620.

In this case, the data required for the detection of abnormal connection may refer to connection data regarding connection between hosts on a network.

In this case, the connection data may include connection start time, connection end time, duration, a source IP address, a destination IP address, a source port, a destination port, a protocol, inbound flow bytes, outbound flow bytes, inbound packets, Out packets, a service name, a service provider, etc.

In this case, the data required for the detection of abnormal connection may be data including connection information.

In this case, the connection information may include a source IP address, a destination IP address, an occurrence count, an average packet count, an average flow count, and recent occurrence time.

In this case, the data required for the detection of abnormal connection may be data including service information.

In this case, the service information may include a service name, a source IP address, and a destination IP address.

Furthermore, the extracted data required for the detection of abnormal connection is stored at step S630.

Furthermore, abnormal connection behavior is detected based on characteristic factors at step S640.

In this case, suspicious abnormal connection data may be extracted based on the data required for the detection of abnormal connection.

In this case, the suspicious abnormal connection data may refer to network data that occurs due to connection that is suspected to correspond to an abnormal state.

In this case, the suspicious abnormal connection data may include network data that occurs at an IP address, which has not been connected previously, outside the network.

In this case, whether the IP address has been connected previously may be determined using information inside connection information data stored in the data storage unit 120.

In this case, a service name and a destination IP address may be extracted from the data required for the detection of abnormal connection, the destination IP address of network data having the same service name may be extracted from service information stored in the data storage unit 120, the destination IP addresses may be compared, and a connection state corresponding to the data required for the detection of abnormal connection may be determined to be a suspicious abnormal connection state if the destination IP addresses do not match each other.

In this case, if a service name cannot be extracted from the data required for the detection of abnormal connection, a destination IP address may be extracted, it may be determined whether network data corresponding to the similar connections of network data having the same IP address is present in service information stored in the data storage unit 120, and a connection state corresponding to the data required for the detection of abnormal connection may be determined to be a suspicious abnormal connection state if similar connections are not present.

In this case, the characteristic factors corresponding to suspicious abnormal connection data may be extracted, characteristic factors corresponding to network data attributable to malicious behavior stored in the data storage unit 120 may be extracted, and the characteristic factors may be compared, thereby detecting abnormal connection.

In this case, if the characteristic factors have similar values, connection in question may be determined to be abnormal connection, and thus the abnormal connection may be detected.

In this case, the characteristic factors may include a used service count, an inbound flow, an outbound flow, connection duration, an In packet count, an Out packet count, a connection count, etc.

In this case, a graph plotting the values of characteristic factors may be output, and the state and similarity of malicious behavior most similar to network data may be also output. An example of this is shown in FIG. 5.

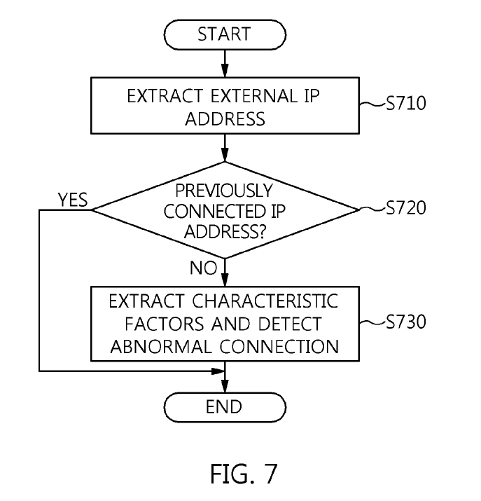

FIG. 7 is an operation flowchart showing the step of detecting abnormal behavior, which is shown in FIG. 6, in greater detail.

Referring to FIG. 7, first, an external IP address is extracted at step S710.

In this case, the external IP address may refer to the IP address of a terminal that connects from the outside of a network to the inside of the network.

In this case, a preciously connected external IP address may be extracted using connection information data stored in the connection information data storage unit 270.

Furthermore, whether the external IP address is a previously connected IP address is determined at step S720.

In this case, if the external IP address is not a previously connected IP address, the characteristic factors of network data corresponding to the external IP address are extracted and abnormal connection is detected based on the characteristic factors at step S730.

In this case, if it is determined through comparison between the characteristic factors that there is a plurality of characteristic factors having similar values, connection in question is determined to be abnormal connection and thus the abnormal connection is detected.

In this case, the characteristic factors may include a used service count, an inbound flow, an outbound flow, connection duration, an In packet count, an Out packet count, a connection count, etc.

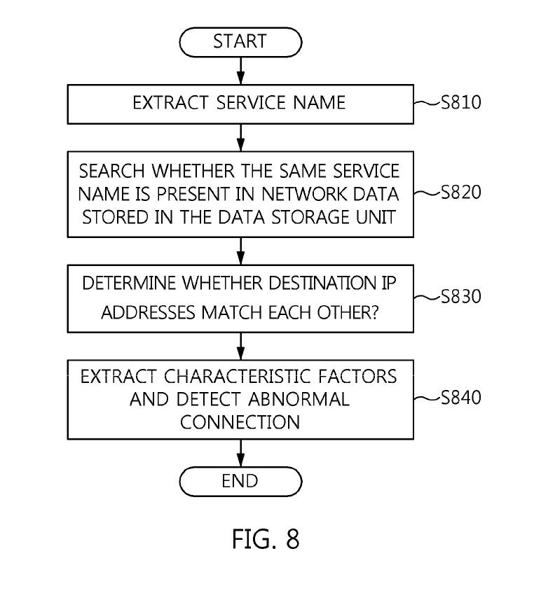

FIG. 8 is an operation flowchart showing the step of detecting abnormal behavior, which is shown in FIG. 6, in greater detail.

Referring to FIG. 8, first, a service name is extracted at step S810.

In this case, the service name refers to the name of a service that is the cause of the transmission and reception of network data.

Furthermore, whether the same service name is present in network data stored in the data storage unit is searched at step S820.

In this case, in the case of network data from which the service name extraction unit 410 cannot extract a service name, it is determined whether a destination IP address corresponding to the network data is an IP address stored in the data storage unit. If the destination IP address corresponding to the network data is an IP address not stored in the data storage unit, data in question may be determined to be suspicious abnormal connection data, and the suspicious abnormal connection data may be extracted.

In the case of data from which a service name cannot be extracted, the data is labeled with Hyper Text Transfer Protocol (HTTP), User Datagram Protocol (UDP), Transmission Control Protocol (TCP) or the like and then collected, and thus suspicious abnormal behavior may be extracted using a destination IP address. A destination IP address may be extracted, it may be determined whether network data corresponding to similar connections that belongs to network data having the same IP address is present in service information stored in the data storage unit 120, and a connection state corresponding to data required for the detection of abnormal connection may be determined to be a suspicious abnormal connection state if there are no similar connections.

Furthermore, it is determined whether destination IP addresses match each other at step S830.

The suspicious abnormal data extraction unit 430 compares an IP address corresponding to network data with an IP address extracted by the destination IP extraction unit, and determines data in question to be suspicious abnormal connection data and then extracts the suspicious abnormal connection data if the IP addresses do not match each other.

In this case, the suspicious abnormal connection data may refer to network data that occurs due to connection that is suspected to correspond to an abnormal state.

Furthermore, characteristic factors are extracted and abnormal connection is detected at step S840.

In this case, if it is determined through comparison between the characteristic factors that there is a plurality of characteristic factors having similar values, connection in question is abnormal connection and thus the abnormal connection is detected.

In this case, the characteristic factors may include a used service count, an inbound flow, an outbound flow, connection duration, an In packet count, an Out packet count, a connection count, etc.

According to at least one embodiment of the present invention, network data is analyzed using characteristic factors, and thus an APT that cannot be detected using a conventional method and that is secretively performed over a continuous period of time can be effectively detected.

According to at least one embodiment of the present invention, abnormal behavior can be detected by selecting only network data corresponding to a service name or a connected external IP address instead of performing total inspection, and thus abnormal behavior can be more rapidly detected.

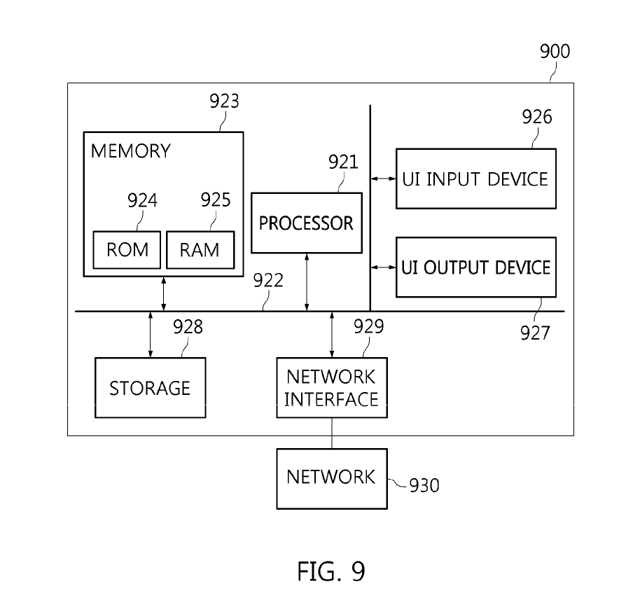

FIG. 9 illustrates a computer that implements an apparatus for detecting abnormal connection behavior based on the analysis of network data according to an example.

The apparatus for detecting abnormal connection behavior based on the analysis of network data may be implemented as a computer 900 illustrated in FIG. 9.

The apparatus for detecting abnormal connection behavior based on the analysis of network data may be implemented in a computer system including a computer-readable storage medium. As illustrated in FIG. 9, the computer 900 may include at least one processor 921, memory 923, a user interface (UI) input device 926, a UI output device 927, and storage 928 that can communicate with each other via a bus 922. Furthermore, the computer 900 may further include a network interface 929 that is connected to a network 930. The processor 921 may be a semiconductor device that executes processing instructions stored in a central processing unit (CPU), the memory 923 or the storage 928. The memory 923 and the storage 928 may be various types of volatile or nonvolatile storage media. For example, the memory may include ROM (read-only memory) 924 or random access memory (RAM) 925.

At least one module of the apparatus for detecting abnormal connection behavior based on the analysis of network data may be configured to be stored in the memory 923 and to be executed by at least one processor 921. Functionality related to the data or information communication of the apparatus for detecting abnormal connection behavior based on the analysis of network data may be performed via the network interface 929. At least one module of the apparatus may include at least one of the data extraction unit 110, data storage unit 120 and detection unit 130.

The at least one processor 921 may perform the above-described operations, and the storage 928 may store the above-described constants, variables and data, etc.

The methods according to embodiments of the present invention may be implemented in the form of program instructions that can be executed by various computer means. The computer-readable storage medium may include program instructions, data files, and data structures solely or in combination. Program instructions recorded on the storage medium may have been specially designed and configured for the present invention, or may be known to or available to those who have ordinary knowledge in the field of computer software. Examples of the computer-readable storage medium include all types of hardware devices specially configured to record and execute program instructions, such as magnetic media, such as a hard disk, a floppy disk, and magnetic tape, optical media, such as compact disk (CD)-read only memory (ROM) and a digital versatile disk (DVD), magneto-optical media, such as a floptical disk, ROM, random access memory (RAM), and flash memory. Examples of the program instructions include machine code, such as code created by a compiler, and high-level language code executable by a computer using an interpreter. The hardware devices may be configured to operate as one or more software modules in order to perform the operation of the present invention, and the vice versa.

At least one embodiment of the present invention provides an operation method and apparatus for implementing a compression function for fast message hashing.

At least one embodiment of the present invention provides an operation method and apparatus for implementing a compression function that are capable of enabling message hashing while ensuring protection from attacks.

At least one embodiment of the present invention provides an operation method and apparatus for implementing a compression function that use combinations of bit operators commonly used in a central processing unit (CPU), thereby enabling fast parallel processing and also reducing the computation load of a CPU.

At least one embodiment of the present invention provides an operation method and apparatus that enable the structure of a compression function to be defined with respect to inputs having various lengths.

Although the present invention has been described in conjunction with the limited embodiments and drawings, the present invention is not limited thereto, and those skilled in the art will appreciate that various modifications, additions and substitutions are possible from this description. For example, even when described technology is practiced in a sequence different from that of a described method, and/or components, such as systems, structures, devices, units, and/or circuits, are coupled to or combined with each other in a form different from that of a described method and/or one or more thereof are replaced with one or more other components or equivalents, appropriate results may be achieved.

Therefore, other implementations, other embodiments and equivalents to the claims fall within the scope of the attached claims.

What is claimed is:

1. An apparatus for detecting abnormal connection behavior, comprising:
a data extraction unit configured to collect network data transmitted and received over a network including a plurality of hosts, and to extract data required for detection of abnormal connection behavior from the network data;
a data storage unit configured to store the extracted data required for detection of abnormal connection behavior; and
a detection unit configured to detect abnormal connection behavior based on characteristic factors corresponding to the stored data required for detection of abnormal connection behavior and characteristic factors corresponding to malicious behavior.

2. The apparatus of claim 1, wherein the characteristic factors comprise any one or more of a used service count, an inbound flow, an outbound flow, connection duration, an In packet count, an Out packet count, and a connection count.

3. The apparatus of claim 2, wherein the data extraction unit comprises:
a raw data extraction unit configured to extract network data, for which a specific or longer period of time has elapsed, from the collected network data;
a connection information data extraction unit configured to extract data corresponding to connection information from the collected network data;
a service information data extraction unit configured to extract data corresponding to service information from the collected network data; and
a malicious behavior data extraction unit configured to extract network data that occurs due to malicious behavior.

4. The apparatus of claim 3, wherein the detection unit comprises:
an external IP address extraction unit configured to extract an external IP address based on information about an IP address included in the data corresponding to the connection information;
a suspicious abnormal data extraction unit configured to check whether the external IP address has been previously connected by comparing an external IP address stored in the data storage unit with the former external IP address, and to extract network data, related to an external IP address that has not been previously connected, as suspicious abnormal behavior data; and
an abnormal connection detection unit configured to detect abnormal behavior based on characteristic factors corresponding to the suspicious abnormal behavior data and characteristic factors corresponding to the malicious behavior.

5. The apparatus of claim 3, wherein the suspicious abnormal behavior extraction unit compares the inbound flow, the outbound flow, the In packet count and the Out packet count included inside the connection data with connection data stored in the data storage unit, and determines that behavior in question is normal behavior if a result value is equal to or lower than a threshold value.

6. The apparatus of claim 3, wherein the detection unit comprises:
a service name extraction unit configured to extract a service name from the service information;
a destination IP extraction unit configured to extract network data having a service name identical to the service name from network data stored in the data storage unit, and to extract a destination IP address corresponding to the network data;
a suspicious abnormal behavior extraction unit configured to compare a destination IP address corresponding to the network data stored in the data storage unit with the destination IP address, and to extract the network data as suspicious abnormal connection data if the destination IP addresses do not match each other; and
an abnormal connection detection unit configured to detect abnormal connection based on characteristic factors corresponding to the suspicious abnormal connection data and characteristic factors corresponding to the malicious behavior.

7. The apparatus of claim 5, wherein the suspicious abnormal behavior extraction unit, in the case of network data from which the service name cannot be extracted, maps the destination IP address against an IP address stored in the data storage unit, determines whether the destination IP address is an IP address stored in the data storage unit, and extracts the network data as suspicious abnormal connection data if the destination IP address is not an IP address stored in the data storage unit.

8. The apparatus of claim 4, wherein the abnormal connection detection unit detects abnormal connection based on similarity between values of the characteristic factors.

9. The apparatus of claim 1, further comprising a graph output unit configured to output the network data represented by the characteristic factors and data corresponding to the malicious behavior in a graph form.

10. A method of detecting abnormal connection behavior, comprising:
collecting network data transmitted and received over a network including a plurality of hosts, and extracting data required for detection of abnormal connection behavior from the network data;
storing the extracted data required for detection of abnormal connection behavior; and
detecting abnormal connection behavior based on characteristic factors corresponding to the stored data required for detection of abnormal connection behavior and characteristic factors corresponding to malicious behavior.

11. The method of claim 10, wherein the characteristic factors comprise any one or more of a used service count, an inbound flow, an outbound flow, connection duration, an In packet count, an Out packet count, and a connection count.

12. The method of claim 11, wherein detecting the data comprises:
extracting network data, for which a specific or longer period of time has elapsed, from the collected network data;
extracting data corresponding to connection information from the collected network data;
extracting data corresponding to service information from the collected network data; and
extracting network data that occurs due to malicious behavior.

13. The method of claim 12, wherein detecting the abnormal connection behavior comprises:
extracting an external IP address based on information about an IP address included in the data corresponding to the connection information;
checking whether the external IP address has been previously connected by comparing an external IP address stored in the data storage unit with the former external IP address, determining network data, related to an external IP address that has not been previously connected, to be suspicious abnormal behavior data, and extracting the suspicious abnormal behavior data; and
detecting abnormal behavior based on characteristic factors corresponding to the suspicious abnormal behavior data and characteristic factors corresponding to the malicious behavior.

14. The method of claim 12, wherein determining network data to be suspicious abnormal behavior data and extracting the suspicious abnormal behavior data comprises comparing the inbound flow, the outbound flow, the In packet count and the Out packet count included inside the connection data with connection data stored in the data storage unit, and determining that behavior in question is normal behavior if a result value is equal to or lower than a threshold value.

15. The method of claim 12, wherein detecting the abnormal connection behavior comprises:
extracting a service name from the service information;
extracting network data having a service name identical to the service name from network data stored in a data storage unit, and extracting a destination IP address corresponding to the network data;
comparing a destination IP address corresponding to the network data stored in the data storage unit with the destination IP address, and extracting the network data as suspicious abnormal connection data if the destination IP addresses do not match each other; and
detecting abnormal connection based on characteristic factors corresponding to the suspicious abnormal connection data and characteristic factors corresponding to the malicious behavior.

16. The method of claim 14, wherein determining network data to be suspicious abnormal behavior data and extracting the suspicious abnormal behavior data comprises, in the case of network data from which the service name cannot be extracted, mapping the destination IP address against an IP address stored in the data storage unit, determining whether the destination IP address is an IP address stored in the data storage unit, and extracting the network data as suspicious abnormal connection data if the destination IP address is not an IP address stored in the data storage unit.

17. The method of claim 13, wherein detecting the abnormal connection behavior comprises detecting abnormal connection based on similarity between values of the characteristic factors.

18. The method of claim 10, further comprising outputting the network data represented by the characteristic factors and data corresponding to the malicious behavior in a graph form.
